(19) United States
(12) Patent Application Publication
(10) Pub. No.: US 2025/0123428 A1
(43) Pub. Date: Apr. 17, 2025

(54) CAMERA MODULES WITH MICRO-SCALE OPTICALLY ABSORPTIVE GRATINGS

(71) Applicant: Apple Inc., Cupertino, CA (US)

(72) Inventors: Yoshikazu Shinohara, Cupertino, CA (US); Chenglin Zhang, Fremont, CA (US); Andrej Halabica, San Jose, CA (US); Ligang Wang, San Jose, CA (US); Yuhong Yao, Tracy, CA (US)

(21) Appl. No.: 18/745,983

(22) Filed: Jun. 17, 2024

Related U.S. Application Data
(60) Provisional application No. 63/543,684, filed on Oct. 11, 2023.

(51) Int. Cl. G02B 5/00

(52) U.S. Cl. CPC G02B 5/003

(57) ABSTRACT

Embodiments described herein relate to camera modules that incorporate an optically absorptive grating that is positioned and designed to reduce the impact of stray light on images captured by the camera modules. Specifically, the optically absorptive grating is configured to absorb light that is incident on the optically absorptive grating. The optically absorptive grating includes an array of protrusions, and in some instances may be part of a grating assembly that is coupled to an optical component.

CROSS-REFERENCE TO RELATED APPLICATION(S)

This application is a nonprovisional and claims the benefit under 35 U.S.C. 119(e) of U.S. Provisional Patent Application No. 63/543,684, filed Oct. 11, 2023, the contents of which are incorporated herein by reference as if fully disclosed herein.

### TECHNICAL FIELD

Embodiments described herein relate to camera modules, and in particular to camera modules including optically absorptive gratings that are configured to absorb light and to spread reflected light that is not absorbed by the absorptive grating.

### BACKGROUND

Cameras continue to be an important feature of consumer electronics devices such as smartphones, tablets, and computers. Stray light, which may result from light reflecting off surfaces within a camera module or entering the camera module through an unintended path, may have a negative impact on images captured by the camera module. For example, stray light may cause lens flares or other artifacts in a captured image. Accordingly, it is desirable to provide stray light mitigation for camera modules.

### SUMMARY

Embodiments described herein relate to camera modules that include optically absorptive gratings. Some embodiments are directed to a camera module including an image sensor, an optical assembly comprising an optical component and configured to direct light towards the image sensor, and a grating assembly coupled to the optical component. The grating assembly may include, a substrate; an adhesive connecting the substrate to the optical component, and a grating formed from an optically absorptive material and positioned on a top surface of the substrate. The grating includes be an array of protrusions.

In some variations, the array of protrusions is a two-dimensional array. In some of these variations, the two-dimensional array includes a first column having a first plurality of protrusions and a second column having a second plurality of protrusions. The first column is staggered with respect to the second column. Additionally or alternatively, each protrusion of the array of protrusions has a pyramid shape. In other variations, the array of protrusions is a one-dimensional array. The optical component is separated from the grating by an air gap. In some variations, the optical component is a prism.

Other embodiments are directed to a camera module that includes an image sensor and an optical assembly that includes a prism formed from an optically transparent material, wherein the optical assembly is configured such that light entering the optical assembly reflects off a surface of the prism via total internal reflection. The camera module includes an optically absorptive grating positioned to face the surface, wherein the grating includes an array of protrusions. In some variations, each protrusion of the array of protrusions has a height of at least 15 microns.

In some variations, the camera module includes a substrate, wherein the optically absorptive grating is positioned on a top surface of the substrate. In some of these variations, the array of protrusions is at least partially formed from the substrate. The optically absorptive grating may include a coating of an optically absorptive material positioned on the top surface of the substrate. In some variations, some or all of the protrusions of the array of protrusions have a triangular cross-sectional shape. In other variations, some or all of the protrusions of the array of protrusions are cones.

Still other embodiments are directed to a camera module having an image sensor, an optical component configured to direct light to the image sensor, and a grating assembly positioned to face a surface of the optical component. The grating assembly includes a substrate and an optically absorptive grating positioned on a surface of the substrate and comprising an array of protrusions. In some variations, the protrusions of the array of protrusions are pyramids. Additionally or alternatively, the grating assembly is coupled to the optical component. In some examples, the protrusions are between 40 μm and 100 μm in height. In some variations, the array of protrusions is a one-dimensional array. In other variations, the array of protrusions is a two-dimensional array.

In some variations, the optically absorptive grating defines an irregular pattern. In other variations, the optically absorptive grating is a two-dimensional array having a plurality of rows and columns and adjacent columns are staggered with respect to each other.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1A shows a rear view of an example electronic device which may include one or more camera modules that incorporate an optically absorptive grating, such as described herein.

FIG. 1B shows a block diagram illustrating components of the example electronic device, such as described herein.

FIG. 2 shows a side view of a portion of a camera module that incorporates an optically absorptive component, such as described herein.

FIG. 3A shows a top view of a grating assembly, such as described herein, that may be incorporated into a camera module.

FIG. 3B shows a cross-sectional side view of a portion of a camera module in which the grating assembly of FIG. 3A is coupled to an optical component.

FIG. 4A shows a top view of a variation of an optically absorptive grating having a one-dimensional array of protrusions. FIGS. 4B and 4C show partial cross-sectional views of variations of the optically absorptive grating of FIG. 4A.

FIGS. 5A and 5B show top views of variations of optically absorptive grating having two-dimensional arrays of protrusions. FIGS. 5C and 5D show perspective views of variations of optically absorptive grating having two-dimensional arrays of protrusions.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments described herein relate to camera modules that incorporate an optically absorptive grating that is positioned and designed to reduce the impact of stray light on images captured by the camera modules. Specifically, the optically absorptive grating is configured to absorb light that is incident on the optically absorptive grating. To the extent that the optically absorptive grating is unable to completely absorb stray light that is incidence on the grating, the optically absorptive grating is further configured to spread light reflected that is not absorbed by the optically absorptive grating. The optically absorptive grating is positioned within the camera module such that stray light may be incident on the optically absorptive grating during operation of the camera module. The optically absorptive grating may reduce the relative amount of stray light that reaches the image sensor during an image capture operation. Specifically, the optically absorptive grating is designed to have a low diffraction efficiency, such that any light reflected by the optically absorptive grating will be spread across several different directions. Accordingly, as stray light is incident on the optically absorptive grating, a small amount of light (if any) may leave the optically absorptive grating in a direction that causes the stray light to be incident on an image sensor of the camera module. To help facilitate this low diffraction efficiency, the optically absorptive grating utilizes micro-scale features (e.g., having dimensions on the order of multiple microns).

Typically, a camera module includes an optical assembly that includes one or more optical components (e.g., lenses, prisms, or the like) that are arranged to collect light from a scene and to focus that light onto an image sensor. In some instances, an optical assembly is configured to fold light along one or more additional axes from an initial axis along which light enters the system. This may reduce the package size of an optical system along one or more dimensions while maintaining a focal length of the optical assembly. For example, a camera module may incorporate a prism, whereby light entering the prism is configured to reflect off of different surfaces of the prism (and thereby fold light along one or more additional axes) before exiting the prism. In some instances, a camera module is designed such that light will reflect off one or more surfaces using total internal reflection. In these instances, these surfaces may not be covered by a reflective coating (e.g., a mirror coating), such that it may be possible for light to exit the prism through these surfaces.

Because total internal reflection at an interface depends on the angle of incidence and the relative refractive indices of the prism and an adjacent medium (e.g., air) forming the interface, it may be possible for stray light to exit from such a prism surface. For example, stray light that enters the prism may be incident on a prism surface at a steeper angle, such that this light is not totally internally reflected. Accordingly, a portion of this stray light may exit the prism and may reach the image sensor if not otherwise mitigated. The optically absorptive gratings described herein may be positioned to receive this stray light, and may reduce the relative amount of stray light that reaches an image sensor.

It should be appreciated that when the terms “optically absorptive” and “optically transparent” are used herein, these are used with respect to the imaging capabilities of the camera. For example, the camera modules described herein may be configured to capture and measure light at one or more wavelengths. For example, some camera modules are configured to measure light at visible wavelengths (e.g., to capture RGB images). Additionally or alternatively, a camera module may be configured to measure light at one or more infrared wavelengths. Accordingly, while these cameras may be exposed to light of a wide range of wavelengths, the images captured by these cameras will only reflect a particular set of wavelengths (also referred to herein as the “operating wavelength range” of the camera module).

Accordingly, when an optical component of a camera module is described herein as being “optically transparent”, it should be appreciated that this optical component is transparent for at least the operating wavelength range of the camera. In this way, a given optical component (e.g., a lens) will be able to route light within the operating wavelength range to an image sensor. These components may be transparent at additional wavelengths, but need not be. Similarly, when an optical component of a camera module is described herein as a being “optically absorptive”, this component is configured to absorb light having a wavelength with the operating wavelength range of the camera. For example, an optically absorptive material may absorb light in the visible range, in the infrared range, combinations thereof, or the like, depending on the operative wavelength range of a given camera module. These components may be able to absorb light at additional wavelengths, but need to be so configured.

The optically absorptive grating is formed from an optically absorptive material, such that light incident on the optically absorptive grating will interact with the optically absorptive material. Additionally, the optically absorptive grating includes an array of protrusions. The shape and size of the protrusions, as well as the arrangement of the protrusions, may be selected in any suitable manner to i) promote absorption of light by the optically absorptive grating and ii) to spread light that is not absorbed across a range of different directions. In some embodiments, the protrusions define surfaces that are oblique relative to a surface of an optical component. Specifically, the optically absorptive grating may be positioned to face a surface of an optical component, and each protrusion may have a corresponding surface that is positioned at an oblique angle relative to the surface of the optical component. This angle may be selected to facilitate absorption of stray light as it exits the surface of the optical component.

The array of protrusions may be configured in a variety of different arrays, such as a one-dimensional or a two-dimensional array. In some instances, a two-dimensional array may be configured as a rectangular grid in which the protrusions are arranged along rows and columns. In other instances, the two-dimensional array may include staggered columns or rows, such that protrusions may be aligned within a column and offset relative to an adjacent column. The protrusions of the array of protrusions may be configured with a range of different shapes. For example, the protrusions may be pyramids, cones, pillars, or the like.

Similarly, the protrusions may have any dimensions as may be desired. For example, in some variations it may be desirable for the size of the protrusions to be larger (e.g., multiple times larger) than the wavelengths of light in the operating wavelength range for a given camera module. This may act to lower the diffraction efficiency of the optically absorptive grating, which may thereby promote spreading of light that is reflected. In some variations, the protrusions of the array of protrusions may have a height of at least 15 microns (μm). In some of these variations, each of the protrusions has a height of at least 40 μm. In some variations, each of the protrusions may have a height between 40 μm and 100 μm. In some of these variations, each of the protrusions may have a height between 50 μm and 80 μm.

Additionally or alternatively, each protrusion of the array of protrusion may have a width of at least 15 μm. In some of these variations, each of the protrusions has a width of at least 40 μm. For example, in some variations, each of the protrusions may have a width between 40 μm and 100 μm. In some of these variations, each of the protrusions may have a width between 50 μm and 80 μm.

In some variations, the optically absorptive grating is formed as a part of a grating assembly. The grating assembly may include a substrate (e.g., formed from polyethylene terephthalate, or the like), and the optically absorptive grating may be positioned on a surface (e.g., a top surface) of the substrate. In some variations, the optically absorptive grating is formed by patterning a surface of the substrate, such that the protrusions are at least partially formed from the substrate. In some of these variations, a coating (e.g., formed from one or more optically absorptive materials) may be deposited on the patterned surface to further promote absorption of the light by the optically absorptive grating. In other variations, an additional layer (e.g., an ink layer) may be deposited on the substrate, and this additional layer may be patterned to define the array of protrusions.

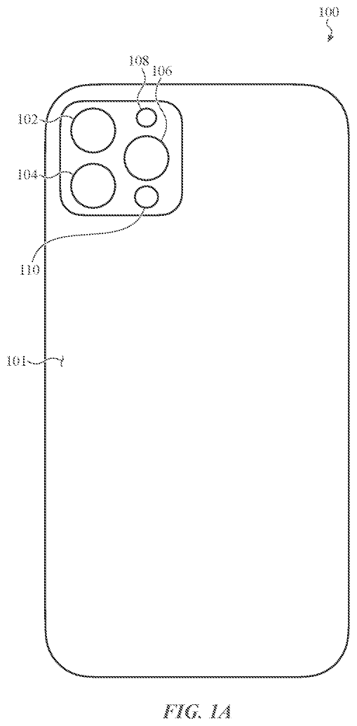

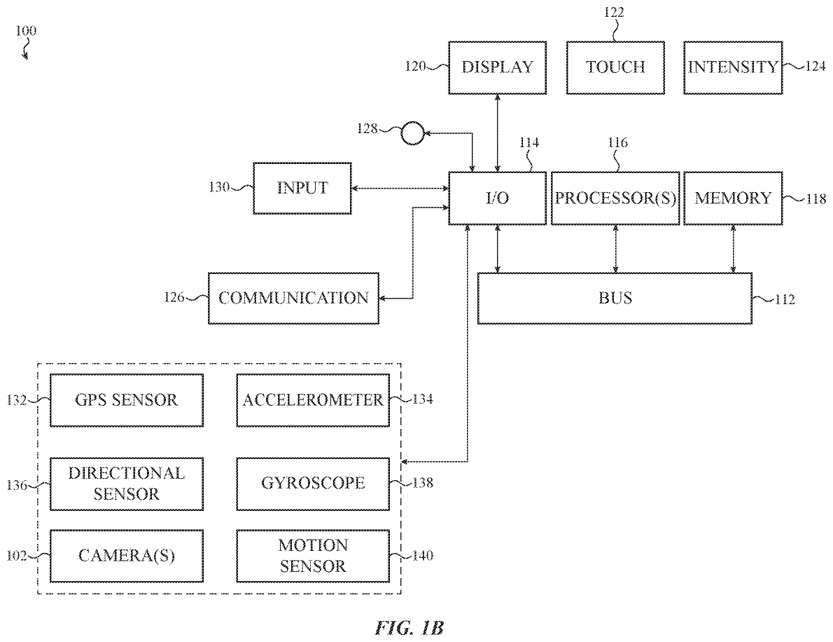

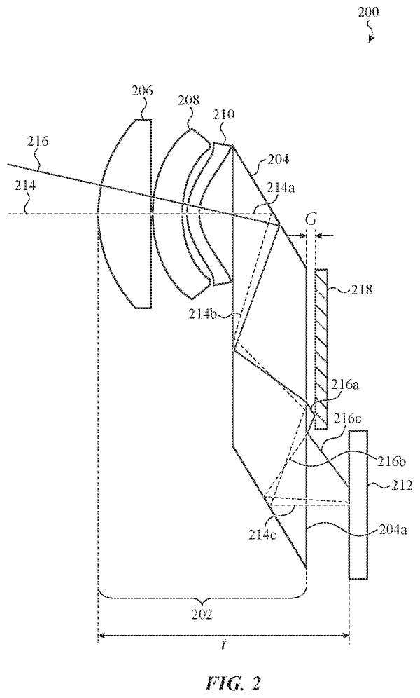

These foregoing and other embodiments are discussed below with reference to FIGS. 1A-5D. However, those skilled in the art will readily appreciate that the detailed description given herein with respect to these figures is for explanation only and should not be construed as limiting.

FIG. 1A shows a rear view of an electronic device 100 which may incorporate one or more cameras that utilize an optically absorptive grating as described herein. The electronic device 100 may include multiple camera modules, such as a first camera module 102, a second camera module 104, and a third camera module 106. While three camera modules are depicted, it should be appreciated that the electronic device 100 may include more or fewer camera modules (including, for example, one or more camera modules on a front or other side of the camera module). Some or all of the camera modules 102, 104, 106 may include the optical grating described herein.

The electronic device may optionally include a flash module 108, a depth sensor 110, and so on. The flash module 108 may provide illumination to some or all of the fields of view of the optical assemblies of the device. This may assist with image capture operations in low light settings. Additionally or alternatively, the device 100 may further include the depth sensor 110 that may calculate depth information for a portion of the environment around the device 100. Specifically, the depth sensor 110 may calculate depth information within a field of coverage (i.e., the widest lateral extent to which the depth sensor 110 is capable of providing depth information). The field of coverage of the depth sensor 110 may at least partially overlap the field of view of one or more of the optical assemblies. The depth sensor 110 may be any suitable system that is capable of calculating the distance between the depth sensor 110 and various points in the environment around the device 100.

FIG. 1B depicts exemplary components of the electronic device 100. In some embodiments, the electronic device 100 has a bus 112 that operatively couples an I/O section 114 with one or more computer processors 116 and a memory 118. The I/O section 114 can be connected to a display 120, which may have a touch-sensitive component 122 and, optionally, an intensity sensor 124 (e.g., contact intensity sensor). In addition, the I/O section 114 can be connected with a communication unit 126 for receiving application and operating system data, using, for example, Wi-Fi, Bluetooth, near field communication (NFC), cellular, and/or other wireless communication techniques. The electronic device 100 may include one or more user input mechanisms, including a first user input mechanism 128 and/or a second user input mechanism 130. The first user input mechanism 128 is, optionally, a rotatable input device or a depressible and rotatable input device, for example. The second user input mechanism 130 is, optionally, a button, in some examples. The electronic device 100 optionally includes various sensors, such as a GPS sensor 132, an accelerometer 134, a directional sensor 136 (e.g., compass), a gyroscope 138, a motion sensor 140, the camera module 102, and/or a combination thereof, all of which can be operatively connected to the I/O section 114.

The memory 118 of electronic device 100 can include one or more non-transitory computer-readable storage mediums, for storing computer-executable instructions, which, when executed by one or more processors 116, for example, can cause the processors 116 to perform the techniques that are described herein. A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The processor 116 can include, for example, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of electronic device 100, as well as to facilitate capturing of images and in-field calibration as described herein. The processor 116 may be referred to herein as processing circuitry.

As described herein, the term “processor” and “processing circuitry” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements. The electronic device 100 is not limited to the components and configuration of FIG. 1B, but can include other or additional components in multiple configurations.

FIG. 2 shows a side view of a portion of a camera module 200. The camera module 200 may be, for example, any camera module of the electronic device 100 of FIG. 1A. As shown in FIG. 2, the camera module 200 may include an optical assembly 202 and an image sensor 212. The image sensor 212 may be any suitable sensor, such as CCD, CMOS sensor, and the like. The image sensor 212 is configured to generate one or more signals that convey information about light received. The optical assembly 202 includes a set of optical components that are configured to route light to the image sensor 212.

For example, the optical assembly 202 may include a prism 204 and a plurality of lenses 206, 208, and 210. In the variation shown in FIG. 2, the lenses 206, 208, and 210 may be positioned and configured to direct light to the prism 204. The lenses 206, 208, and 210 may be held in a fixed relationship with respect to each other and the prism 204 (e.g., using a lens barrel to hold some or all of the lenses 206, 208, and 210), or maybe moveable relative to each other and/or the prism 204. The optical assembly 202 may be positioned behind a cover window of the electronic device, such that light from an outside environment may received by the optical assembly 202 through the cover window. Each of the optical components may be formed from a corresponding optically transparent material, such as a glass or plastic, which may facilitate the optical assembly 202 routing light within the operating wavelength range of the camera module 200 to the image sensor 212.

The prism 204 is configured to fold light along different axes. As shown in FIG. 2, the prism 204 forms a parallelogram. However, the particular shape may vary, as will be readily understood by one of ordinary skill in the art. Incoming light 214 may enter the optical assembly along a first axis (represented by path 214a), and may reflect off of multiple surfaces within the prism 204 (represented by path 214b) before exiting the prism 204 (e.g., along path 214c). Light exiting the prism 204 may be directed to the image sensor 212, and may be measured as part of an image capture operation.

In some instances, the light 214 may be configured to reflect off of one or more surfaces via total internal reflection. For example, the prism 204 may utilize total internal reflection to reflect light off a bottom surface of the prism. In some of these variations, at least a portion of the bottom surface may have an air interface, such that the bottom surface is not otherwise coated with a reflective coating. Accordingly, if light is incident on this surface with a steep enough angle, some of the light may exit the bottom surface of the prism.

For example, if stray light 216 enters the camera at an unexpected angle (or otherwise bounces off another component within the camera module), this stray light 216 may be incident on the bottom surface of the prism at an angle of incidence that does not support total internal reflection (e.g., at a steeper angle). As a result, as this stray light 216 is incident on the bottom surface of the prism, at least a portion of the stray light 216 may exit the bottom surface of the prism. If this stray light 216 is not controlled, it may reach the image sensor 212 and cause lens flare or other artifacts in images captured by the camera module 200.

In some instances, the camera module may include an optically absorptive component 218 positioned to face the prism 204 (e.g., a portion of the bottom surface of the prism 204). This optically absorptive component 218 may include a sheet that is formed from and/or coated with an optically absorptive material. Accordingly, the stray light 216 may exit the prism 204 and be incident on the optically absorptive component 218 (e.g., along path 216a). Some of the stray light 216 may be absorbed, however some fraction of the light may also be reflected off of the optically absorptive component 218. This reflected portion of the stray light 216 may reenter the prism 204 (e.g., along path 216b) and/or reflect off of the prism 204 (e.g., along path 216c), which may cause a portion of the stray light 216 to reach the image sensor 212. Accordingly, this stray light 216 may create lens flare or other artifacts in images captured by the camera module 200.

By modifying the optically absorptive component 218 to have an optically absorptive grating, such as those as described herein, the portion of the stray light 216 that is reflected off of the optically absorptive component 218 may be spread across multiple different directions. As a result, an even smaller percentage of the stray light 216 will reach the image sensor 212, which may mitigate, or in some instances altogether remove, image artifacts that would have otherwise occurred.

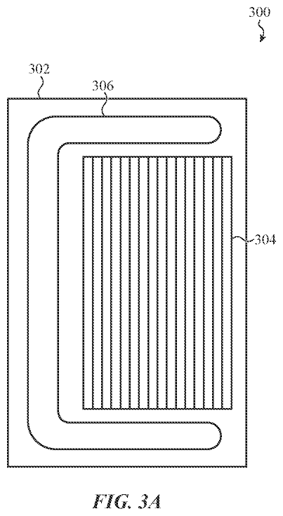

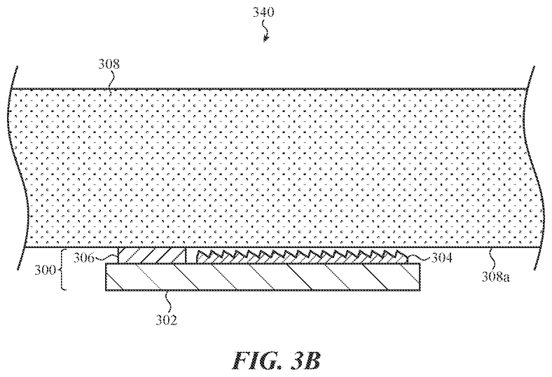

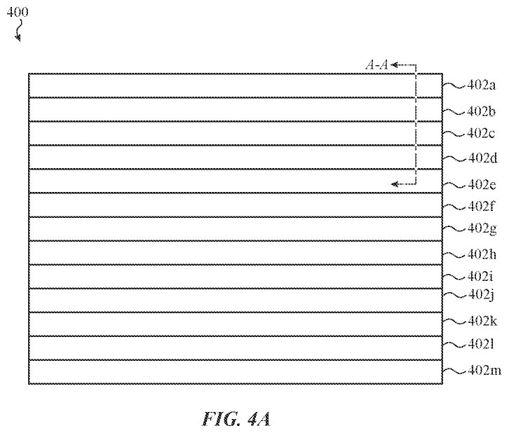

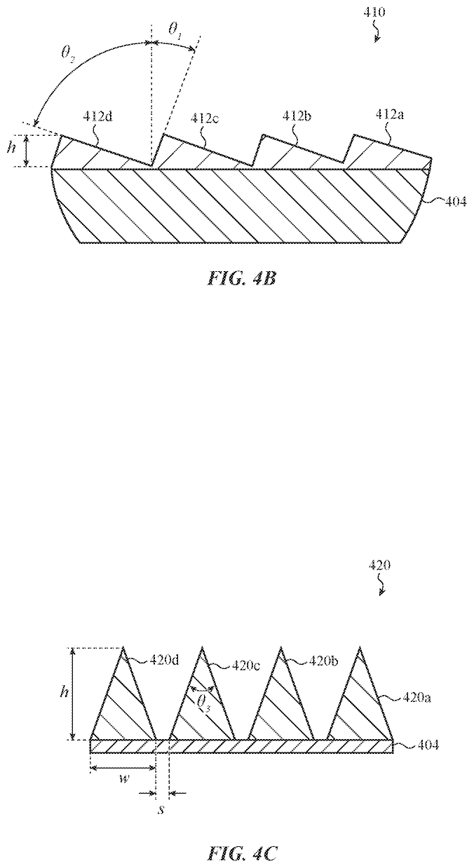

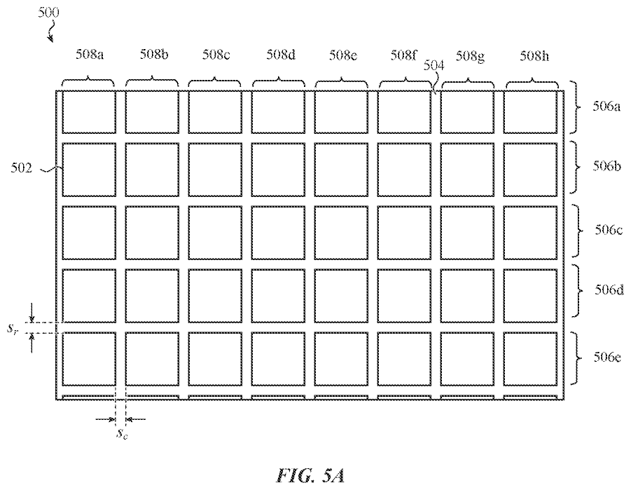

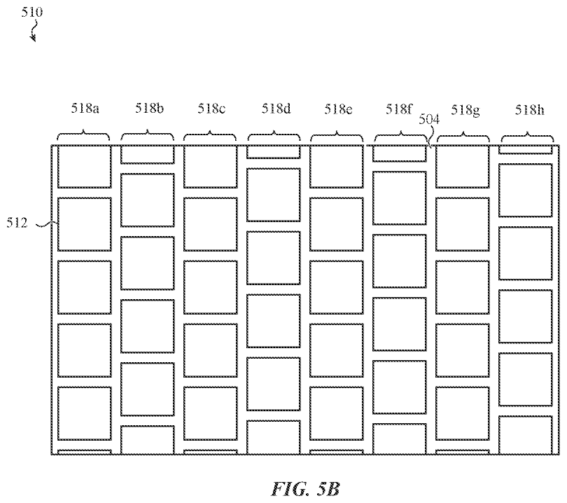

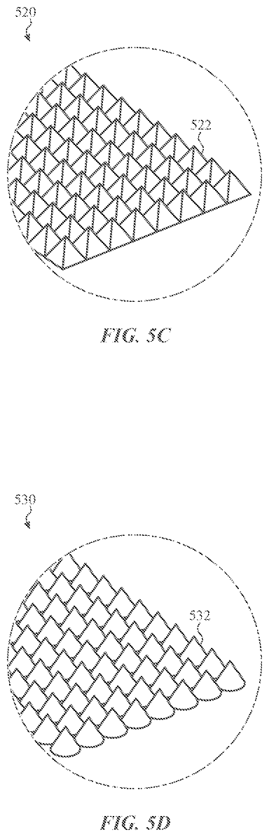

For example, FIG. 3A shows a top view of a grating assembly 300 that includes a substrate 302 having an optically absorptive grating 304. The optically absorptive grating 304 includes an array of protrusions that may be configured in any manner as described herein, such as those described with respect to the gratings of FIGS. 4A-5D. The optically absorptive grating 304 may be positioned on a particular surface (e.g., a top surface) of the substrate 302, and may be formed from or formed on that surface of the substrate 302. For example, optically absorptive grating 304 may be formed by patterning the top surface of the substrate 302 to define the array of gratings (which may or may not be coated with one or more additional absorptive materials such as described herein). In other instances, the optically absorptive grating 304 may be formed by patterning another material (e.g., an ink layer) that is deposited on or otherwise connected to the substrate 302. Overall, the optically absorptive grating 304 is formed from one or more optically absorptive materials, such that the optically absorptive grating 304 is configured to absorb light that is incident on the optically absorptive grating 304.

In some variations, the substrate 302 may be coupled to an optical component to position the optically absorptive grating 304 relative to the optical component. For example, the grating assembly 300 shown in FIG. 3A includes an adhesive 306 that maybe used to couple the substrate 302 to an optical component. The adhesive 306 may be disposed over a portion of the substrate 302 and at least partially surround the optically absorptive grating 304. The adhesive 306 may be any suitable adhesive, such as a pressure-sensitive adhesive or the like, that is able to bond the substrate 302 to the optical component (or whichever component to which the substrate is being connected).

FIG. 3B shows a cross-sectional side view of a portion of a camera module 340 in which the grating assembly 300 of FIG. 3A is coupled to an optical component 308. The optical component 308 may be any optical component of an optical assembly of a camera module, such as the prism 204 of the camera module 200 of FIG. 2 (e.g., the grating assembly 300 may replace the optically absorptive component 218 of FIG. 2). As depicted in the FIG. 3B, the grating assembly 300 is positioned such that the optically absorptive grating 304 faces a portion of corresponding surface 308a the optical component 308. Specifically, the surface 308a may represent a surface through which stray light may exit the optical component 308. Accordingly the optically absorptive grating 304 is positioned to receive this stray light and reduce the relative amount of this stray light that will reach an image sensor (not shown) of the camera module 340, such as the image sensor 212 of the camera module 200 of FIG. 2).

In the variation shown in FIG. 3B, the adhesive 306 couples the substrate 302 to the optical component 308. In some examples, the adhesive 306 may coupled the substrate 302 to a portion of the surface 308a of the optical component 308. In some variations, the surface 308a of the optical component may be partially coated with an optically absorptive material (e.g., an absorptive mask), and the adhesive 306 may positioned in portions of the surface 308a that are coated with the optically absorptive material. In other variations, the grating assembly 300 may be positioned in the camera module 340 without being coupled to the optical component. For example, the substrate may be coupled (e.g. via the adhesive 306) to another component within the camera module 340. This component may hold the substrate 302 in place relative to the optical component 308. In these instances, the optically absorptive grating may still face the surface 308a and may thereby mitigate the effects of stray light exiting the surface 308a of the optical component 308.

The optically absorptive grating 304 includes an array of protrusions that may have any suitable configuration, such as described herein. In some variations, the optically absorptive grating 304 may include a one-dimensional array of protrusions. FIG. 4A shows a top view of an example optically absorptive grating 400 that is configured as a one-dimensional array of protrusions 402a-402m. In these instances, the protrusions 402a-402m are aligned along a single dimension. In other words, the array of protrusions 402a-402m includes a single row that includes all of the protrusions 402a-402m.

The protrusions 402a-402m may be shaped to define one or more surfaces, which may be positioned and angled to promote absorption and spreading of incoming stray light. FIGS. 4B and 4C show partial cross-sectional views of variations of the optically absorptive grating 400 of FIG. 4A, taken along line A-A. It should be appreciated that the cross-sectional shapes of the protrusions shown in FIGS. 4B and 4C may also be representative of cross-sectional shapes of protrusions of optically absorptive gratings having a two-dimensional array of protrusions.

FIG. 4B shows a variation of an optically absorptive grating 410 that includes an array of protrusions 412a-412d that form a continuous pattern of oblique surfaces. In these instances, there is no spacing between adjacent protrusions (e.g., one surface of a first protrusion 412a shares an edge with a surface of an adjacent second protrusion 412b, and so on). Each protrusion has a height h, which represents the height along a vertical dimension between the highest and lowest points of the protrusion. The height of the protrusions 412a-412d may be any suitable values, such as those described above.

The protrusions 412a-412d may extend vertically from a surface of a substrate 404, and may be formed from or formed on the substrate in any manner as described herein. The substrate 404 may define a plane, and the protrusions 412a-412d may each define one or more surfaces that are positioned at an oblique angle relative to the plane of the substrate 404. For example, in the variation shown in FIG. 4B, each protrusion of the array of protrusions 412a-412d has a triangular cross-sectional shape that defines a first oblique surface and a second oblique surface. Specifically, the first oblique surface is tilted at a first oblique angle θ₁ with respect to a vertical dimension (e.g., normal to the plane of the substrate 404). Similarly, the protrusion 402c may also define a second oblique surface that is tilted at a second oblique angle θ₂. In some cases, the first oblique angle θ₁ may be smaller than the second oblique angle θ₂. Overall, the height of each protrusion, the width of each protrusions, the first oblique angle θ₁ of the first oblique surface and the second oblique angle θ₂ of the second oblique surface may be selected to tailor the performance of the optically absorptive grating 410 for a given camera module.

FIG. 4C shows another variation of an optically absorptive grating 420 that includes an array of protrusions 420a-420d. In this variation, each protrusion has a height h and a width w, and is separated from adjacent protrusions by a non-zero separation distance s. The separation distance s may be selected along with the dimension of the protrusions 420a-420d to adjust the performance of the desired grating. The values of the height h and the width w of the protrusions may be any suitable values, such as those described in more detail herein. It should be appreciated, however, that in some instances the optically absorptive grating 420 may have an array of protrusions 420a-420d may have the same shape as shown in FIG. 4C, but may be formed as a continuous pattern (e.g., the separation distance s between adjacent protrusions is zero).

The protrusions 412a-412d may extend vertically from a surface of a substrate 404, and may be formed from or formed on the substrate in any manner as described herein. In the variation shown in FIG. 4C, each of the protrusions 412a-412d has a prism shape with a triangular cross-sectional shape, each having an apex angle θ₃. In some cases, the apex angle θ₃ may be less than 60°, less than 40°, or the like. Additionally, while the protrusions 421a-421d are shown in FIG. 4C as each having a cross-sectional shape that forms an isosceles triangle, it should be appreciated that in other instances the protrusions have a triangular cross-sectional shape that forms a non-isosceles triangle.

FIG. 5A shows top view of a portion of an optically absorptive grating 500 having a two-dimensional array of protrusions. The protrusions 502 may extend vertically from a surface of a substrate 504, and may be formed from or formed on the substrate 504 in any manner as described herein. In the variation in FIG. 5A, the protrusions 502 are arranged in rows and columns to form a grid. Accordingly, the optically absorptive grating 500a includes a plurality of rows 506a-506e and a plurality of columns 508a-508h, each of which includes a plurality of protrusions 502. In some variations, the optically absorptive grating 500 may be configured such that there is a first spacing s, between adjacent rows of the plurality of rows 506a-506c (e.g., the protrusions 502 within a column may be separated by the first spacing sᵣ). Similarly, in some variations, the optically absorptive grating 500 may be configured such that there is a second spacing s_{c} between adjacent columns of the plurality of columns 508a-508h (e.g., the protrusions 502 within a row may be separated by the second spacing s_{c}).

FIG. 5B shows a top view of another variation of an optically absorptive grating 510 having a two dimensional array of protrusions 512. In this variation, the protrusions 512 are arranged into staggered columns. Specifically, the array of protrusions includes a plurality of columns 518a-518h, each of which includes plurality of protrusion. Adjacent columns of the plurality of columns 518a-518h may be offset, such that the protrusions of one column (e.g., a first column 518a) are not aligned with the protrusions of an adjacent column (e.g., a second column). In this way, while the protrusions are arranged into columns, they may not also be arranged into rows.

While FIGS. 5A and 5B depict two examples of optically absorptive gratings having a two-dimensional array of protrusions, other configurations are envisioned. In some cases the optically absorptive grating may define a concentric pattern having protrusions radially separated. In other examples, the protrusions may be disposed as a hexagonal pattern. In yet other examples, the protrusions may define an irregular pattern with different heights and distances.

It should also be appreciated that each protrusion in a two-dimensional array of protrusions may have any suitable shape. For example, each protrusion may be a wedge, a pyramid, a cone, or the like. For example, FIG. 5C shows a perspective view of a portion of an optically absorptive grating 520 that includes a two-dimensional array of protrusion 522, where each protrusion 522 has a pyramid shape. Accordingly, the protrusion 522 may each define three or more surfaces depending on the shape of the based of the pyramid. For example, while the protrusions 522 are shown in FIG. 5C as a square pyramid shape (e.g., having a square base), in other instance, the protrusions 522 may have a triangular pyramid shape (e.g., having a triangular base), a pentagonal pyramid shape (e.g., having a pentagonal based), or the like. In some instances the pyramids that form the protrusions 522 may be right pyramids (e.g., having an apex centered over the base) or oblique pyramids (e.g., having an apex that is not centered over the base). FIG. 5D shows a perspective view of a portion of an optically absorptive grating 530 that includes a two-dimensional array of protrusion 532, where each protrusion 532 has a cone shape. It should be appreciated that the protrusions 522, 532 of the respective optically absorptive gratings 520, 530 of FIGS. 5C and 5D may have cross-sectional shapes and dimensions as described above with respect to FIGS. 4B and 4C.

These foregoing embodiments depicted in FIGS. 1A-5D and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. A camera module comprising:
an image sensor;
an optical assembly comprising an optical component and configured to direct light towards the image sensor; and
a grating assembly coupled to the optical component, the grating assembly comprising:
a substrate;
an adhesive connecting the substrate to the optical component; and
a grating formed from an optically absorptive material and positioned on a top surface of the substrate, wherein the grating comprises an array of protrusions.

2. The camera module of claim 1, wherein the array of protrusions is a two-dimensional array.

3. The camera module of claim 2, wherein:
the two-dimensional array comprises a first column comprising a first plurality of protrusions and a second column comprising a second plurality of protrusions; and
the first column is staggered with respect to the second column.

4. The camera module of claim 2, wherein each protrusion of the array of protrusions has a pyramid shape.

5. The camera module of claim 1, wherein the array of protrusions is a one-dimensional array.

6. The camera module of claim 1, wherein the optical component is separated from the grating by an air gap.

7. The camera module of claim 1, wherein the optical component is a prism.

8. A camera module comprising:
an image sensor;
an optical assembly comprising a prism formed from an optically transparent material, wherein the optical assembly is configured such that light entering the optical assembly reflects off a surface of the prism via total internal reflection; and
an optically absorptive grating positioned to face the surface, wherein the grating comprises an array of protrusions.

9. The camera module of claim 8, wherein:
each protrusion of the array of protrusions has a height of at least 15 μm.

10. The camera module of claim 8, comprising a substrate, wherein the optically absorptive grating is positioned on a top surface of the substrate.

11. The camera module of claim 10, wherein the array of protrusions is at least partially formed from the substrate.

12. The camera module of claim 11, the optically absorptive grating comprises a coating of an optically absorptive material positioned on the top surface of the substrate.

13. The camera module of claim 8, wherein each protrusion of the array of protrusions has a triangular cross-sectional shape.

14. The camera module of claim 8, wherein each protrusion of the array of protrusions is a cone.

15. A camera module comprising:
an image sensor;
an optical component configured to direct light to the image sensor;
a grating assembly positioned to face a surface of the optical component, the grating assembly comprising:
a substrate; and
an optically absorptive grating positioned on a surface of the substrate and comprising an array of protrusions.

16. The camera module of claim 15, wherein the protrusions of the array of protrusions are pyramids.

17. The camera module of claim 15, wherein:
the grating assembly is coupled to the optical component.

18. The camera module of claim 15, wherein the protrusions of the array of protrusions are between 40 μm and 100 μm in width.

19. The camera module of claim 15, wherein the array of protrusions is a one-dimensional array.

20. The camera module of claim 15, wherein:
wherein the array of protrusions is a one-dimensional array.
